(19) United States
(12) Patent Application Publication
(10) Pub. No.: US 2021/0049384 A1
(43) Pub. Date: Feb. 18, 2021

(54) SYSTEMS AND METHODS FOR COLLECTING INFORMATION FROM A VEHICLE FOR DAMAGE ASSESSMENT CAUSED BY RIDERS

(71) Applicant: Toyota Motor North America, Inc., Plano, TX (US)

(72) Inventors: Jacob Ryan Morrow, Carrollton, TX (US); Armin Lange, Addison, TX (US)

(21) Appl. No.: 16/541,586

(22) Filed: Aug. 15, 2019

(51) Int. Cl. G06K 9/00; G07C 5/08; B60R 11/04; G07C 5/00; G06Q 40/08; G06T 7/00

(52) U.S. Cl. CPC G06K 9/00832; G07C 5/0866; B60R 11/04; B60R 2011/0028; G06Q 40/08; G06T 7/0002; G06K 9/00335; G07C 5/008

(57) ABSTRACT

Systems, methods, and other embodiments described herein relate to collecting information from a vehicle for damage assessment. In one embodiment, a method includes, in response to receiving a ride request from a user, identifying attributes associated with the user in relation to a ride. The method includes monitoring the user and the vehicle to collect, from one or more vehicle systems of the vehicle, vehicle state information associated with the ride including analyzing sensor data using at least image recognition to generate the vehicle state information. The method includes generating a ride report specifying at least changes in a condition of the vehicle according to the vehicle state information and scoring the vehicle state information according to a heuristic to assess an impact of the user on the vehicle. The method includes electronically communicating the ride report to provide a real-time assessment of the user on the vehicle.

### TECHNICAL FIELD

The subject matter described herein relates in general to systems for collecting information from a vehicle, and, more particularly, to monitoring a user and the vehicle over a ride to assess damage to the vehicle by the user.

### BACKGROUND

As modes of transportation continue to shift away from personally-owned vehicles towards Mobility-as-a-Service (MaaS) solutions, the availability of convenient, cost-effective transportation is increasing. By way of example, a user can utilize a rideshare application for transportation to and from a sporting event in a metropolitan area as an affordable alternative to paying for parking and fuel. Other conveniences can include saving time via closer drop-offs proximate to the venue and avoiding worries about vandalism or scratches and dents to the user's vehicle. However, damage to a rideshare vehicle by the user is difficult to track. In some cases, the damage initially goes unnoticed, which further complicates determining the responsible user. Traditional insurance models do not generally extend to MaaS services such as ridesharing. Personal vehicle insurance carriers may not cover damage caused by the user during a MaaS ride. Additionally, transportation providers may be operating on small profit margins making it difficult to afford insurance that covers user damage. As a result of these circumstances, users may incur exorbitant cleaning fees and other expenses that are, in some cases, fraudulent.

### SUMMARY

In one embodiment, example systems and methods relate to a manner of monitoring a user and an associated vehicle over a rideshare trip to collect information for use in assessing damage to the vehicle by the user. In one embodiment, the disclosed systems and methods monitor the vehicle and the user to collect vehicle state information over the ride. In this way, the system can assess an impact of the user on the vehicle and provide an immutable record of the ride that facilitates avoiding the noted difficulties. Accordingly, if the impact rises to an apparent level of damage to the vehicle, the noted systems and methods can electronically communicate a ride report including rider information to an owner of the vehicle. Moreover, in one arrangement, the disclosed systems and methods can electronically communicate a notification to the user and the owner in real-time when the impact exceeds the apparent level of damage. For example, the notification can include the ride report, i.e., the immutable record, so that both parties have the same information detailing the assessed damage to the vehicle by the user.

Additionally, the disclosed systems and methods, in one embodiment, authenticates the user and determines whether the user carries an insurance policy that covers user damage for the rideshare trip. For example, a ride request from the user is denied as a result of inadequate or missing coverage. Hence, the burden of carrying insurance that covers damage caused by the user is essentially shifted to the user. In addition to the ride report, the noted systems and methods, in one arrangement, electronically communicate user's insurance policy information to the owner, as well as automatically process a third-party claim for the user. Furthermore, the disclosed systems and methods, in one embodiment, generate the ride report specifying changes in the interior condition of the vehicle that are attributable to the user over the ride. In this way, appropriate cleaning fees and charges can be assessed, and the shared ride report can eliminate fraudulent claims.

In one embodiment, a collection system for collecting information from a vehicle to access damage during a ride is disclosed. The collection system includes a camera within the vehicle, one or more processors in communication with the camera, and a memory communicably coupled to the one or more processors. The memory stores a collection module that includes instructions that when executed by the one or more processors cause the one or more processor to, in response to receiving a ride request from a user, identify attributes associated with the user in relation to the ride. The collection module further includes instructions to monitor the user and the vehicle to collect, from one or more vehicle systems of the vehicle, vehicle state information associated with the ride including using at least image recognition on image data collected from the camera to generate the vehicle state information. The memory stores a report module including instructions that when executed by the one or more processors cause the one or more processor to generate a ride report specifying at least changes in a condition of the vehicle according to the vehicle state information. The report module further includes instructions to score the vehicle state information according to a heuristic to assess an impact of the user on the vehicle and to belectronically communicate the ride report to provide a real-time assessment of the user on the vehicle.

In one embodiment, a non-transitory computer-readable medium is disclosed. The computer-readable medium stores instructions that when executed by one or more processors cause the one or more processors to perform the disclosed functions. The instructions include instructions to, in response to receiving a ride request from a user, identify attributes associated with the user in relation to a ride. The instructions include instructions to monitor the user and a vehicle to collect, from one or more vehicle systems of the vehicle, vehicle state information associated with the ride including analyzing sensor data using at least image recognition to generate the vehicle state information. The instructions include instructions to generate a ride report specifying at least changes in a condition of the vehicle according to the vehicle state information. The instructions to generate the ride report include instructions to score the vehicle state information according to a heuristic to assess an impact of the user on the vehicle. Furthermore, the instructions include instructions to electronically communicate the ride report to provide a real-time assessment of the user on the vehicle.

In one embodiment, a method of collecting information from a vehicle for damage assessment during a ride is disclosed. The method includes, in response to receiving a ride request from a user, identifying attributes associated with the user in relation to the ride. The method includes monitoring the user and the vehicle to collect, from one or more vehicle systems of the vehicle, vehicle state information associated with the ride including analyzing sensor data using at least image recognition to generate the vehicle state information. The method includes generating a ride report specifying at least changes in a condition of the vehicle according to the vehicle state information and scoring the vehicle state information according to a heuristic to assess an impact of the user on the vehicle. Further, the method includes electronically communicating the ride report to provide a real-time assessment of the user on the vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a collection system that is associated with collecting information from the vehicle for damage assessment during a ride.

FIG. 3 illustrates one embodiment of the collection system of FIG. 2 in a cloud-computing environment.

FIG. 4 illustrates one embodiment of a method that is associated with collecting vehicle state information associated with a ride.

FIG. 5 is a schematic of an example environment in which the disclosed systems and methods may operate.

### DETAILED DESCRIPTION

Systems, methods, and other embodiments associated with collecting vehicle state information for assessing damage to a rideshare vehicle by a user are disclosed. As mentioned previously, traditional insurance models do not generally cover personal vehicles used for rideshare purposes. In particular, personal car insurance policies often exclude “driving-for-hire.” Even if the rideshare service provider offers supplemental insurance to an owner of a rideshare vehicle, the damage by the user may not be covered. Furthermore, a user's rideshare account may incur excessive charges due to stains, spills, or other damage during a ride, which, in some cases, may not be a fault of the user, but cannot be proven otherwise.

Therefore, a collection system, as disclosed herein, facilitates shifting the burden of insuring against the damage to the rideshare vehicle (hereinafter referred to as “vehicle”) to the user. Thus, in one embodiment, the collection system, in response to receiving a ride request from the user, is implemented to identify attributes associated with the user including assessing a scope of coverage for a rideshare. For example, the collection system can deny the ride request according to the scope of coverage. In one embodiment, the collection system monitors the user and the vehicle to collect, from one or more vehicle systems and/or a sensor system of the vehicle, vehicle state information. The vehicle state information, for example, includes images of an interior of the vehicle before and after the ride, video of the user, and dynamic vehicle data over the ride. In one arrangement, the collection system is implemented to monitor the vehicle by analyzing image data collected from a camera within the vehicle using image recognition. For example, the system executes one or more image recognition techniques (e.g., a machine learning algorithm performing image classification) to identify changes in an interior condition of the vehicle over the ride. In particular, the machine learning algorithm learns via a training process to automatically detect and classify damage of a vehicle interior as embodied in the image data.

Accordingly, in one embodiment, the collection system generates a ride report specifying the changes in the interior condition according to the vehicle state information. For example, the ride report includes an assessment of an impact of the user on the vehicle. In one arrangement, the collection system electronically communicates a notification to the user and the owner when a real-time assessment of the impact exceeds a defined damage criterion. Moreover, the collection system, in one arrangement, electronically communicates the ride report and insurance policy information to the owner and processes a third-party claim for the owner. In this way, to secure the rideshare, the user needs an appropriate insurance policy, which makes the user ultimately responsible for the damage he or she causes to the vehicle. Additionally, the ride report includes the damage attributable to the user, thus associating the damage with an appropriate user, which is important when there are additional rideshare passengers in the vehicle. Thus, the ride report may promote accurate insurance claims and allocate, as well as validate, charges for damages.

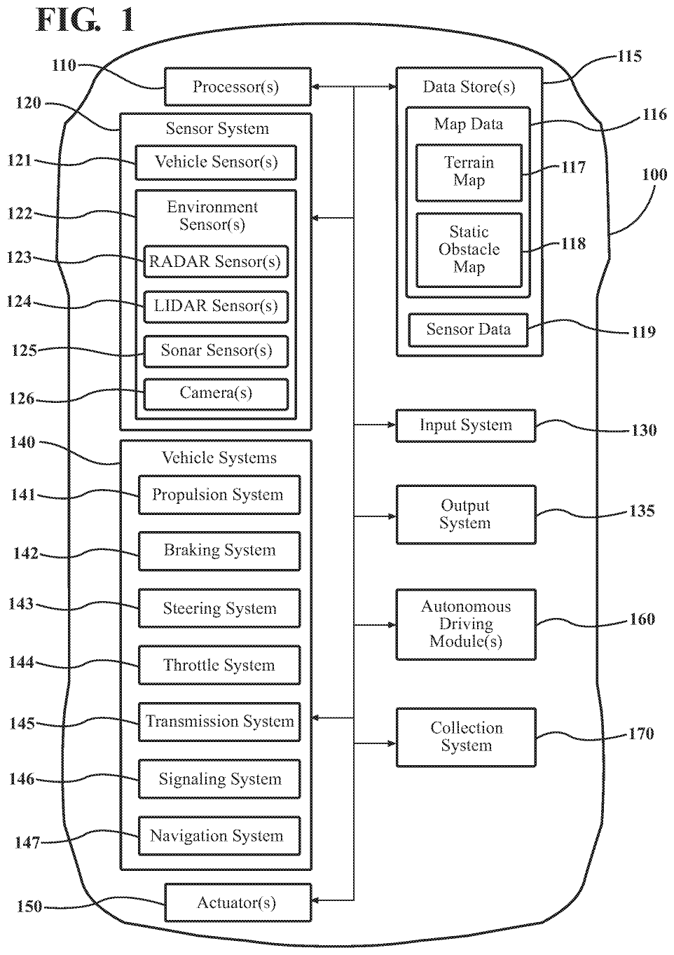

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any other form of motorized transport (e.g., buses, trains, airplanes, etc.) that, for example, benefits from collecting information from the vehicle 100 for damage assessment as discussed herein. It should be noted that the particular vehicle 100 may be an autonomous vehicle 100 or any type of transportation within the context of MaaS where a user is a passenger, e.g., ridesharing, ride-hailing, carpooling, e-hailing, etc.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. Further, while the various elements are shown as being located within the vehicle 100 in FIG. 1, it will be understood that one or more of these elements can be located external to the vehicle 100. Further, the elements shown may be physically separated by large distances.

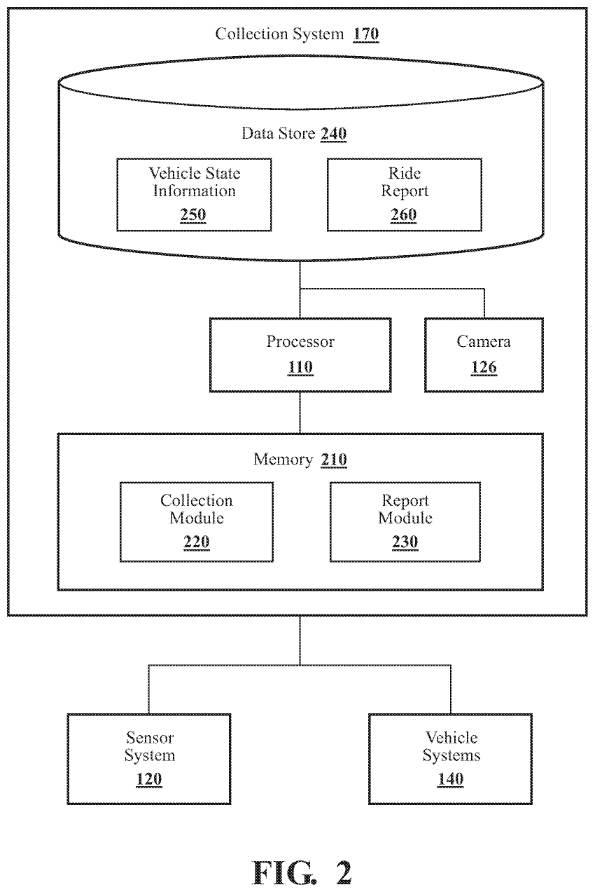

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the vehicle 100 includes a collection system 170 that is implemented to perform methods and other functions as disclosed herein relating to collecting information from the vehicle 100 for damage assessment during a ride. The noted functions and methods will become more apparent with a further discussion of the figures.

With reference to FIG. 2, one embodiment of the collection system 170 of FIG. 1 is further illustrated. The collection system 170 is shown as including a processor 110 from the vehicle 100 of FIG. 1. Accordingly, the processor 110 may be a part of the collection system 170, the collection system 170 may include a separate processor from the processor(s) 110 of the vehicle 100, or the collection system 170 may access the processor 110 through a data bus or another communication path. In one embodiment, the collection system 170 includes a memory 210 that stores a collection module 220 and a report module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the processor 110 cause the processor 110 to perform the various functions disclosed herein.

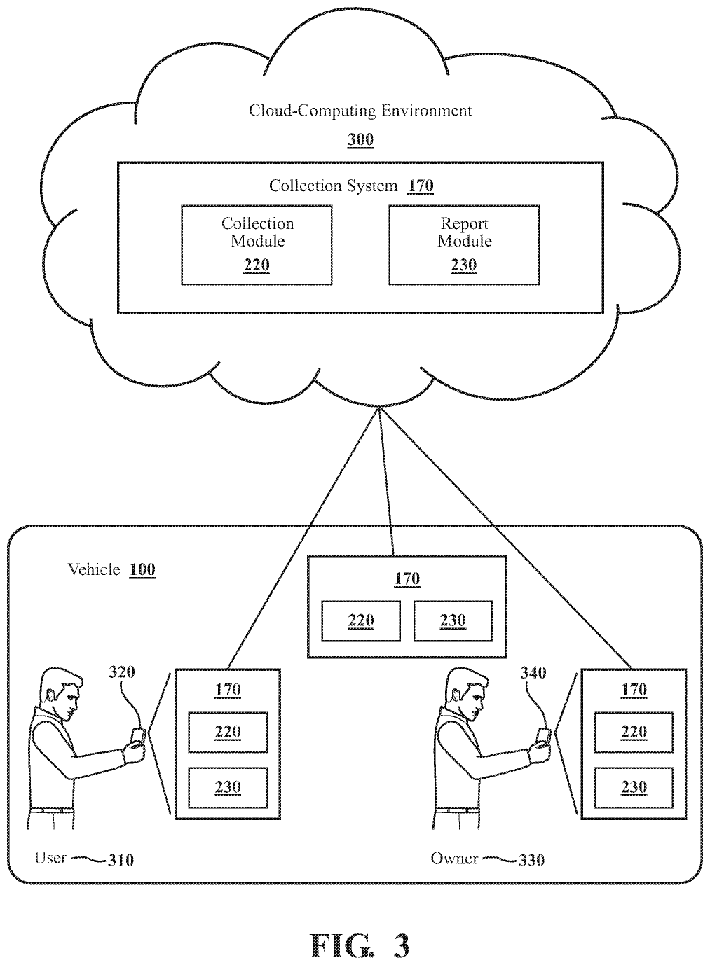

The collection system 170, as illustrated in FIG. 2, is generally an abstracted form of the collection system 170 as may be implemented between the vehicle 100, a cloud-computing environment, and mobile devices. FIG. 3 illustrates one example of a cloud-computing environment 300 that may be implemented along with the collection system 170. As illustrated in FIG. 3, the collection system 170 is embodied in part within the cloud-computing environment 300, the vehicle 100, and also within a mobile device 320 of a user 310 and a mobile device 340 of an owner 330 of the vehicle 100. That is, the vehicle 100, the mobile device 320, the mobile device 340, and the cloud-computing environment 300 include, in one or more embodiments, the modules 220 and 230 or at least relevant portions thereof. Other abstractions are possible, for example, the user 310 and/or the owner 330 may communicate directly with the vehicle 100, and/or the user 310 and the owner 330 may communicate directly with each other. It should be appreciated that the collection system 170 may be integrated with a ridesharing/ride-hailing application that the user 310 accesses to secure transportation from a MaaS service provider (e.g., the owner 330) via the cloud-computing environment 300. For example, the ridesharing/ride-hailing application (e.g., Uber, Lyft, etc.) may process the logistics of the ride (e.g., pickup/drop-off locations, account charges, etc.) in parallel with the collection system 170. It should also be appreciated that the owner 330 may not be the driver or physically reside in the vehicle 100. For example, the vehicle 100 may be autonomous, i.e., driverless, or the owner 330 is remotely located and employs the driver.

Accordingly, in one embodiment, the collection module 220 generally includes instructions that function to control the processor 110 to identify attributes associated with the user 310 in relation to a ride that the user 310 requested. By way of example, when the user 310 wishes to hail a ride, the user 310 may generate a ride request (e.g., via an application running on the mobile device 320) that is communicated through a wireless cellular connection or other communications link and received by the collection module 220. The collection module 220 can process the ride request to identify specific attributes of the user 310 that are associated with the current ride. For example, the ride request can indicate a user rating (e.g., an accumulated ride score from other drivers/owners), a number of passengers accompanying the user, user identity information, a source of data (e.g., a location of a remote server for gathering additional attributes of the user), and so on. In one implementation, the collection module 220 can access the remote server (e.g., by applying credentials supplied with the ride request) to further identify attributes associated with the user, such as whether the user 310 is properly insured for the ride.

Moreover, the collection module 220, in one embodiment, generally includes instructions to monitor the user 310 and the vehicle 100 to collect, from one or more vehicle systems 140 and/or a sensor system 120, vehicle state information 250. As will be discussed in further detail below, the vehicle state information 250 is used by the collection system 170 for the damage assessment of the vehicle 100 from the user. The vehicle state information 250 can be in the form of images taken before and after the ride that depict an interior of the vehicle 100. The vehicle state information 250 can be in the form of video taken over the ride that can identify a behavior (e.g., aggressive, reckless, passive, etc.) of the user. The collection module 220 can determine the behavior from, for example, image recognition techniques described below.

Additionally, the vehicle state information 250 can be in the form of dynamic vehicle data (e.g., data from a vehicle CAN-bus, vehicle sensor data, telematics from the vehicle, etc.) collected over the ride. For example, the dynamic vehicle data can include GPS coordinates of the vehicle 100, accelerometer data, braking data, steering data, duration of travel, weather conditions, time of day, level of traffic, current speed, temperature, number of passengers, vehicle diagnostics (e.g., current codes and history codes), and other data collected by the collection module 220 from different sensors and systems of the vehicle 100. The collection module 220, in one embodiment, can identify a behavior of the vehicle 100 from the dynamic vehicle data over the ride. For example, the behavior of the vehicle 100 can include acceleration/deceleration profiles, braking profiles, steering profiles, a list of vehicle sensors and diagnostic codes activated over the ride, etc.

As shown in FIG. 2, the collection system 170 includes a camera 126 or may access a camera through a communication pathway (e.g., a system bus, wireless communication link, etc.). The camera 126, in one arrangement, can be located within the vehicle 100, and the vehicle state information 250 can include image data of an interior of the vehicle 100 collected by the camera 126. Moreover, the collection module 220 can generate the vehicle state information 250 by analyzing the image data using at least image recognition. As set forth below, the image recognition can identify changes in an interior condition of the vehicle 100 over the ride, and the changes may pertain to varying levels of damage to the interior of the vehicle 100.

Furthermore, the collection system 170, in one embodiment, also includes the report module 230 that generally includes instructions that function to control the processor 110 to score the vehicle state information 250 according to a heuristic. The heuristic assesses an impact of the user 310 on the vehicle 100. For example, the heuristic can access the vehicle state information 250 to determine the changes, i.e., the various levels of damage that occurred, to the vehicle 100 over the ride. Accordingly, in one embodiment, the report module 230 executing the heuristic can correlate the changes to the user 310 and score the changes. For example, the scored changes can be compared to a threshold to determine whether the changes are considered apparent damage to the vehicle 100 from the perspective of the owner 330.

Additionally, the report module 230, in one embodiment, can generate a ride report 260 specifying at least the changes in a condition of the vehicle 100 according to the vehicle state information 250. For example, as a result of the impact surpassing the threshold, i.e., a defined damage criterion, the report module 230 can electronically communicate the ride report and insurance policy information to the owner 330. Moreover, the report module 230, in one arrangement, processes a third-party claim for the owner 330. Furthermore, in one arrangement, the report module 230 can electronically communicate the ride report 260 in real-time to provide an assessment of the user 310 on the vehicle 100 throughout the ride. For example, the report module 230 can electronically notify the user 310 and the owner 330 with the ride report 260 when the real-time assessment of the impact exceeds the defined damage criterion.

Accordingly, in one embodiment, the collection system 170 includes a data store 240. The data store 240 is, in one embodiment, an electronic data structure for storing information. For example, in one approach, the data store 240 is a database that is stored in the memory 210 or another suitable medium, and that is configured with routines that can be executed by the processor 110 for analyzing stored data, providing stored data, organizing stored data, and so on. In either case, in one embodiment, the data store 240 stores data used by the modules 220 and 230 in executing various functions. In one embodiment, the data store 240 includes the vehicle state information 250 and the ride report 260 along with, for example, other information that is used by the modules 220 and 230. The vehicle state information 250 can include, for example, metadata that characterize various aspects of the vehicle state information 250. For example, the metadata can include location coordinates (e.g., longitude and latitude), relative map coordinates, time/date stamps from when the vehicle state information 250 is collected, and so on. It should be appreciated that the collection system 170 can track the user 310 across more than one vehicle of a MaaS service request.

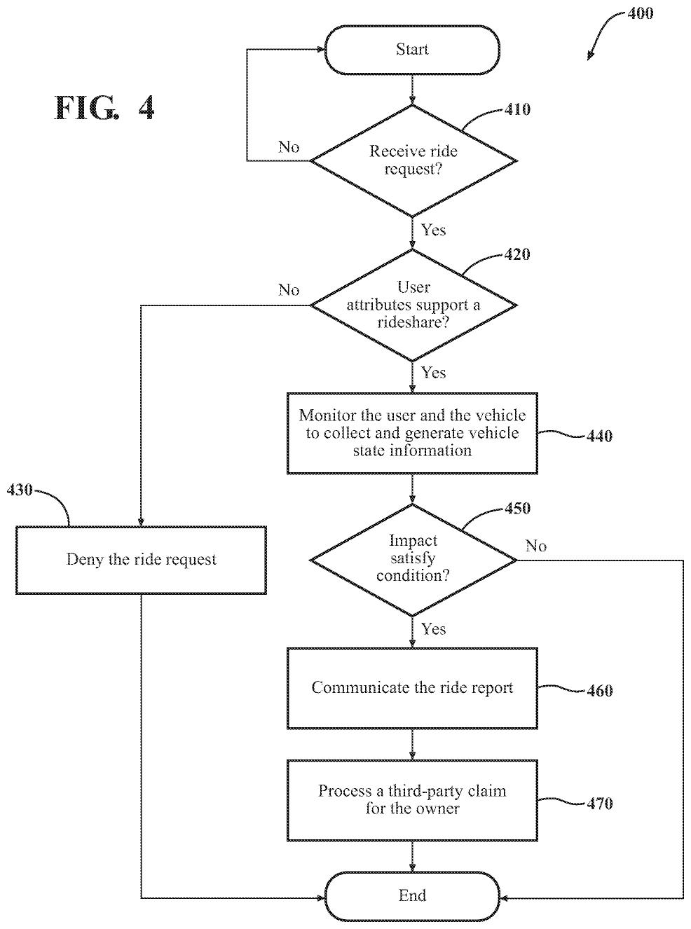

Additional aspects of collecting the vehicle state information 250 to perform damage assessment will be discussed in relation to FIG. 4. FIG. 4 illustrates a flowchart of a method 400 that is associated with collecting vehicle state information 250 for the damage assessment during the ride. Method 400 will be discussed from the perspective of the collection system 170 of FIGS. 1-3. While method 400 is discussed in combination with the collection system 170, it should be appreciated that the method 400 is not limited to being implemented within the collection system 170, but is instead one example of a system that may implement the method 400.

At 410, the collection module 220 monitors for the ride request. In one embodiment, the ride request is a communication issued by the user 310 for requesting a ride from the MaaS service provider, e.g., via the mobile device 320. For example, the collection system 170 can be integrated with a rideshare/ride-hailing application, and the collection module 220 can receive the ride request from the rideshare/ride-hailing application. Alternatively, the collection module 220 can monitor for the ride request, for example, in parallel with the rideshare/ride-hailing application, by monitoring one or more communication networks (e.g., cellular, wifi, satellite, etc.) in order to identify when the ride request is provided. In further embodiments, the collection module 220 can monitor for the ride request via local ports (e.g., serial ports, USB ports, etc.) of the vehicle 100 as provided through a physical connection.

At 420, the collection module 220 identifies attributes of the user 310 for determining whether the user 310 carries appropriate insurance for a rideshare trip that covers user damage. In one embodiment, the collection module 220 identifies attributes associated with the user 310 in relation to the ride. The collection module 220 can process the ride request to identify specific ride-related attributes. For example, the ride request can indicate a source of where the ride-related attributes are found (e.g., a web address of a remote server). Further, the ride request can indicate other ride-related attributes, which can be utilized by the collection system 170 (e.g., the user rating, the number of passengers, the user identity information, etc.), as set forth below. Alternatively, the collection module 220 may receive the ride-related attributes associated with the user 310 from the rideshare/ride-hailing application.

Furthermore, in one arrangement, the collection module 220 accesses the remote server, for instance, as directed by the web address specified in ride request, to retrieve insurance data from an insurance policy of the user. For example, the web address can point to a secure server maintained by an insurance company associated with the user. The credentials to gain access to the secure server can be indicated in the ride request. In one arrangement, the collection module 220 analyzes the insurance data to assess a scope of coverage in relation to the rideshare trip. That is, the collection module 220 can determine, for example, various coverage levels (e.g., full vehicle, rear seat only, etc.), vehicle components covered as a result of the damage caused by the user, insurance riders that cover family members traveling with the user, etc.

Alternatively, the collection module 220 may accept the ride request when the ride is determined not to be within the scope of coverage. In this case, the owner 330 accepts the risk of the user damage. The owner 330 may configure the collection module 220 to accept ride requests when the scope of coverage, or portions thereof, are not adequate, e.g., via a settings menu within an application running on the mobile device 340 of the owner 330. For example, the owner 330 may charge a higher fare for the ride to compensate for accepting the risk.

At 430, the collection module 220 denies the ride request. In one embodiment, the collection module 220 denies the ride request when the ride is determined not to be within the scope of coverage. Therefore, the owner 330 is not willing to accept the risk of an uninsured user. It should be appreciated that accepting or denying the ride request does not necessarily cancel the ride. Ride cancellation is typically a function of the rideshare/ride-hailing application that can be integrated with, or running alongside the collection system 170. Thus, acceptance of the ride request by the collection module 220 indicates to the owner 330 and the user 310 that the collection system 170 will continue to operate. For example, the collection system 170 will continue with monitoring the user 310 and the vehicle 100, collecting and generating vehicle state information 250, assessing the impact of the user 310 on the vehicle 100, and generating the ride report 260, as described above and described in greater detail below. In one arrangement, the collection module 220 can transmit a message to the mobile device 320 of the user 310 that includes, for example, a statement that the ride request is denied due to a lack of a user damage insurance policy.

At 440, the collection module 220 collects vehicle state information 250. In one embodiment, the collection module 220 monitors the user 310 and the vehicle 100 to collect the vehicle state information 250 associated with the ride from one or more vehicle systems 140, including the sensor system 120. In one or more arrangements, the vehicle state information 250 can include the images of the vehicle 100 before and after the ride that depict an interior of the vehicle 100, the video of the user 310 over the ride, and the dynamic vehicle data while the user 310 engages with the vehicle 100. For example, the video can be used by the collection module 220 to identify the behavior of the user 310 (e.g., using image recognition techniques described below). Furthermore, the dynamic vehicle data can be used by the collection module 220 to identify the behavior of the vehicle 100 over the ride.

Additionally, the collection module 220, in some arrangements, can collect vehicle state information 250 from the mobile devices 320 and 340, or external devices, such as infrastructure cameras, or the like. By way of example, the vehicle 100 may not be equipped with exterior cameras, and the collection module 220 may collect images of an exterior of the vehicle 100 from the mobile devices 320 and 340. In other arrangements, the collection module 220 can collect vehicle state information 250 simultaneously from the vehicle 100 and the mobile devices 320 and 340. In this case, the collection module 220 can correlate the vehicle state information 250 and/or collect redundant vehicle state information 250.

Moreover, in one embodiment, the collection module 220 authenticates the user 310 to the ride request. In one arrangement, the ride request includes attributes associated with the user 310 that uniquely identifies the user. For example, the ride request can include the user identity information, such as a unique digital key, or the like. Additionally, the collection module 220 can match the user identity information to, for example, unique identity data stored under a user account in the data store 240. The unique identity data can include, for example, facial image data of the user, fingerprint data of the user, MAC address of the mobile device 320, Bluetooth identifier of the mobile device 320, radio frequency identification (RFID) data from an RFID tag, etc. The collection module 220 can monitor the user 310 as the user 310 approaches the vehicle 100, enters the vehicle 100, and/or occupies a seat in the vehicle 100 via the sensor system 120. For example, the camera 126 can collect a facial image of the user, and in one arrangement, the collection module 220 can employ image recognition techniques to compare the facial image to the facial image data stored under the user account to authenticate the user. Alternatively, other biometric data, such as a digital fingerprint, can be received from an input system 130 of the vehicle 100 (e.g., a digital fingerprint reader mounted in the vehicle 100), and the collection module 220 can compare the digital fingerprint to the fingerprint data under the user account to authenticate the user. The collection module 220 can use any suitable authentication method now known or later developed for authenticating the user 310 to the user identity information.

Furthermore, in one embodiment, the collection system is implemented to monitor image data collected from the camera 126 using the image recognition to identify the changes in the interior of the vehicle 100 over the ride. The image data may be the images from the vehicle 100 before and after the ride that depict the interior of the vehicle 100. Alternatively, or in addition to, the image data may be collected throughout the ride, for example, from extracting still images from the video of the user. The collection module 220, in one arrangement, employs the image recognition to execute a machine learning algorithm that implements image classification to identify the changes in the interior condition of the vehicle 100. Moreover, in one embodiment, the collection module 220 uses the image data as an electronic input to a deep learning algorithm. The deep learning algorithm is, for example, a convolutional neural network (CNN) or another machine learning approach that has been trained to perform, for example, object detection and classification, semantic segmentation, temporal comparative analysis of images, or a similar approach on the image data. Accordingly, the collection module 220 implements the deep learning algorithm to detect and classify the changes as embodied in the collected image data. In general, the deep learning algorithm can be trained to detect and classify changes as they relate to damage of an interior of a vehicle 100.

At 450, the report module 230 assesses the damage to the vehicle 100. In one embodiment, the report module 230 scores the vehicle state information 250 according to the heuristic to assess the impact of the user 310 on the vehicle 100. The heuristic can access the vehicle state information 250 to determine the changes to the condition of the vehicle 100 over the ride. The changes can be to the interior of the vehicle 100 embodied as various levels of damage to the interior via machine learning techniques, as set forth above. The changes can be to the exterior of the vehicle 100 embodied as various levels of damage to the exterior, for example, as determined by the machine learning techniques described above, using images of the exterior of the vehicle 100 before and after the ride.

Additionally, in one embodiment, the heuristic assesses the vehicle state information 250 before the ride and establishes an initial condition and a presence of pre-existing conditions of the vehicle 100 prior to the entry by the user. The heuristic can use the initial condition as a baseline from which the collection module 220 can begin monitoring the user 310 and the vehicle 100 to collect vehicle state information 250. The initial condition can include a date and a time the ride begins, a state of the sensor system 120, a state of the vehicle diagnostics, an inventory of all components and their associated condition on the interior and the exterior of the vehicle 100, etc. The pre-existing conditions can be, for example, a condition of the seats, floors, floor mats, interior door panels, headliner, exterior body panels, etc. The heuristic can apply the pre-existing condition when the heuristic assesses the impact of the user 310 on the vehicle 100. Furthermore, the report module 230 can store the initial condition and pre-existing conditions in the data store 240.

Moreover, the heuristic can correlate the changes to the user 310 by using the vehicle state information 250 that is time-stamped from, for example, one or more of the initial condition, the pre-existing conditions, the images of the vehicle 100 before and after the ride, the dynamic vehicle data, the behavior of the user, and the behavior of the vehicle 100. By way of example, the machine learning techniques detect and classify a change to the interior rear door as “missing” a door handle. In this case, the initial condition, images of the interior that are time-stamped, and vehicle sensor data from the door jam switch place the door handle in the vehicle 100 while the user 310 was engaged with the vehicle 100. As another example, the machine learning techniques detect and classify a change to a floor in the interior of the vehicle 100 as a small red spot. Accordingly, the pre-existing condition did not contain the red spot and time-stamped images of the interior associate the damage to the user. As another example, the machine learning techniques detect and classify an indentation to the driver's side front body panel as a dent. In this case, the initial condition, the behavior of the user 310 as hostile and interfering with the driver, and the vehicle behavior (e.g., the steering and the braking profiles) correlate the dented body panel to the user.

Accordingly, in one embodiment, the heuristic scores the changes to the condition of the vehicle 100 that correlate to the user. For example, the heuristic can access a lookup table stored in the data store 240 that cross-references the changes, i.e., a level of damage, to a damage value. For example, the damage value can have a range from 1-100 where a damage value of “1” would associate with a blemish in the seat, i.e., normal wear and tear, and a damage value of “100” would associate with a heavily damaged vehicle. Furthermore, the damage value can be utilized by the heuristic to assess the impact of the user 310 on the vehicle 100, e.g., the greater the damage value, the greater the impact is on the vehicle 100 because of the user. Other suitable scoring methods may be utilized by the report module 230 to quantify varying levels of damage.

Additionally, in one embodiment, the report module 230 can analyze the impact to determine whether an apparent level of damage occurred to the vehicle 100 according to the defined damage criterion. For example, the impact can be analyzed as a result of the collection module 220 determining that the ride is within the scope of coverage. The damage criterion can be a specific damage value, above which is considered apparent damage to the vehicle 100 from the perspective of the owner 330. In other words, the damage criterion can be assigned by the owner 330 of the vehicle 100 and can correspond to the apparent level of damage that the owner 330 subjectively considers as actual damage for which compensation is the remedy. In one arrangement, the damage criterion is configurable, and the owner 330 can assign the damage criterion via an application running on the mobile device 340 of the owner 330.

Furthermore, when other passengers are present in the vehicle 100 besides the user, the report module 230, in one arrangement, can parse the vehicle state information 250 to extract state information associated with the user. For example, the collection module 220, in one arrangement, can determine the number of passenger from the vehicle state information 250 and/or the ride-related attributes of the ride request. Further, the report module 230, in one arrangement, can score the state information associated with the user 310 according to the heuristic to assess the impact on the vehicle 100 directly attributable to the user 310 in comparison to the other passengers. In one embodiment, when the additional passengers are, for example, family and friends covered under the insurance policy or the insurance rider of the user, the report module 230 can parse the vehicle state information 250 to extract the state information associated to a group linked with the insurance policy.

At 460, the report module 230 generates the ride report 260. In one embodiment, the report module 230 generates the ride report 260 specifying at least changes in the condition of the vehicle 100 according to the vehicle state information 250. For example, the ride report 260 can include the changes to the interior of the vehicle 100 and the exterior of the vehicle 100 regardless of the associated damage value. The ride report 260 can include a time-stamp associated with the change, and the changes that exceed the damage criterion can be highlighted. Furthermore, the report module 230 can generate the ride report 260 to include changes in the condition of the vehicle 100 regardless of whether the changes are associated with the user.

Additionally, the report module 230, in one embodiment, can electronically communicate the ride report 260 and the insurance policy information obtained from the insurance data to the owner 330 of the vehicle 100 when the impact of the user 310 on the vehicle 100 exceeds the damage criterion. For example, the ride report 260 and the insurance policy information can be electronically communicated at the end of the ride.

Moreover, the report module 230, in one arrangement, can electronically communicate the ride report 260 to provide a real-time assessment of the user 310 on the vehicle 100. In one implementation, the report module 230 can electronically communicate a notification to the user 310 and the owner 330 in real-time when the impact of the user 310 on the vehicle 100 exceeds the damage criterion. In this case, the report module 230 can wirelessly transmit the ride report 260 to the mobile device 320 of the user 310 and/or the mobile device 340 of the owner 330. The report module 230, in one embodiment, can distinguish in the ride report 260 those changes associated with the user. In either case, the report module 230 can store the ride report 260 in the data store 240.

At 470, the report module 230 processes the third-party claim for the owner 330. In one embodiment, the report module 230 can automatically process the third-party claim when the impact of the user 310 on the vehicle 100 exceeds the damage criterion in accordance with the scope of the coverage. For example, the report module 230 can access the remote server using the web address and credentials specified in the ride request to file the third-party claim. The third-party claim can include, for example, the changes that are within the scope of coverage, the associated vehicle state information 250, vehicle identification number (VIN), etc. Alternatively, or in addition to, the report module 230 can automatically process a claim for the user 310 when the impact of the user 310 on the vehicle 100 exceeds the damage criterion. Additionally, settings for processing the insurance claim can be configurable, e.g., via an application running on the mobile device 320 of the user 310 and the owner 330. For example, the settings may include options for automatic/manual claim generation, for including additional images, etc.

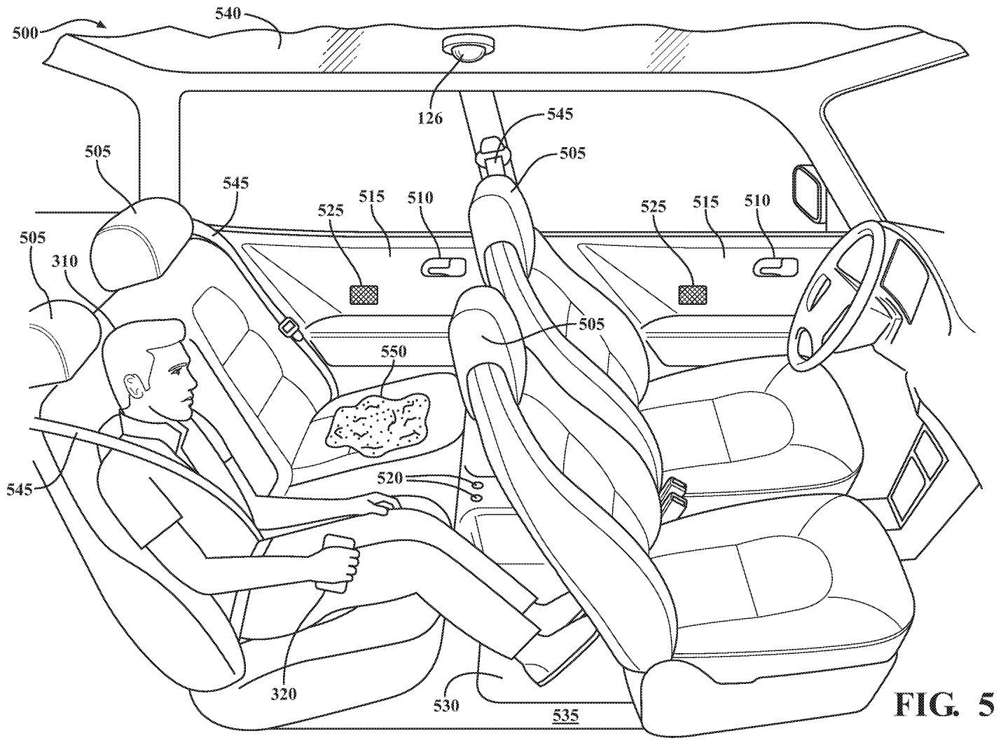

As a further example, FIG. 5 illustrates a schematic of an autonomous vehicle 500 providing a MaaS transportation service for the user 310. An interior of the autonomous vehicle 500 is illustrated with the user 310 occupying a seat 505 during a ride. With brief reference to FIG. 3, the configuration of FIG. 5 would modify FIG. 3 such that an owner 330 and mobile device 340 are either remotely located or integrated with the cloud-computing environment 300.

Moreover, the heuristic executed by the report module 230 assesses the vehicle state information 250 collected from the collection module 220 to establish an initial condition and pre-existing conditions of the autonomous vehicle 500 before the user 310 enters the autonomous vehicle 500. Further, the initial condition and pre-existing conditions established by the heuristic reveal components, for example, the seats 505, door handles 510, interior door panels 515, radio knobs 520, speakers 525, floor mats 530, floors 535, a headliner 540, etc., are present and that the associated changes (e.g., from when the components were new) are applied to the pre-existing conditions. For example, the report module 230 via the heuristic can establish the initial condition (e.g., as the state of the sensor system 120, the state of the vehicle diagnostics, etc.) and pre-existing conditions when the ride request is accepted.

Continuing with the discussion of FIG. 5, the vehicle state information 250 can begin to be collected by the collection module 220 after the initial condition and pre-existing conditions are established. The collection module 220 can monitor the interior of the autonomous vehicle 500 to collect images before and after the ride and/or during the ride. The collection module 220 can monitor the user 310 by collecting video of the user 310 from the camera 126 to identify the behavior of the user. The collection module 220 can monitor the autonomous vehicle 500 to collect dynamic vehicle data, e.g., time-of-day, a locked/unlocked status of a seatbelt 545, occupant seat detection status, speed of the autonomous vehicle 500, accelerometer data, etc.

Furthermore, during the ride and at the end of the ride, the report module 230 generates the ride report 260 specifying the changes in the condition of the autonomous vehicle 500. For example, the ride report 260 includes the change to the condition of the seats 505, which the machine learning techniques detect and classify as a red stain 550. The heuristic correlates the red stain 550 to the user 310 from the initial condition, pre-existing conditions, i.e., no red stain present, and the changes collected in the vehicle state information 250 over the ride. Thereafter, the heuristic can score the change, determine the damage value, and assess the impact of the user 310 on the autonomous vehicle 500. For example, the red stain 550 can be assessed as an impact substantial enough to exceed the damage criterion, as specified by the owner 330 of the autonomous vehicle 500.

Accordingly, the report module 230 can generate the ride report 260 specifying the changes to the condition of the autonomous vehicle 500, which includes the red stain 550. Thereafter, the report module 230 can electronically communicate the notification to the user 310 and the owner 330 in real-time when the red stain 550 occurred by wirelessly transmitting the ride report 260 to the user 310 and the owner 330. Additionally, the report module 230 can electronically communicate the ride report 260 and the insurance policy information of the user 310 to the owner 330 at the end of the ride. Furthermore, the report module 230 can automatically process and file a third-party claim for the owner 330.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle 100 is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route. Additionally, a vehicle operator (i.e., driver) provides inputs to the vehicle 100 to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangement, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangement, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor(s) 110 to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes and data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g. a driver or a passenger). The vehicle 100 can include an output system 135. An “output system” includes any device, component, or arrangement or groups thereof that enable information/data to be presented to a vehicle passenger (e.g. a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the collection system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110 and/or the autonomous driving module(s) 160 may control some or all of these vehicle systems 140 and, thus, may be partially or fully autonomous.

The processor(s) 110 and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110 and/or the autonomous driving module(s) 160 can control the direction and/or speed of the vehicle 100. The processor(s) 110 and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by the processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by the one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110 , and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 can be configured to collect information about and/or determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g. one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A collection system for collecting information from a vehicle for damage assessment during a ride, comprising:
a camera within the vehicle;
one or more processors, the one or more processors in communication with the camera;
a memory communicably coupled to the one or more processors and storing:
a collection module including instructions that when executed by the one or more processors cause the one or more processor to, in response to receiving a ride request from a user, identify attributes associated with the user in relation to the ride,
wherein the collection module includes instructions to monitor the user and the vehicle to collect, from one or more vehicle systems of the vehicle, vehicle state information associated with the ride including using at least image recognition on image data collected from the camera to generate the vehicle state information; and
a report module including instructions that when executed by the one or more processors cause the one or more processor to generate a ride report specifying at least changes in a condition of the vehicle according to the vehicle state information,
wherein the report module includes instructions to score the vehicle state information according to a heuristic to assess an impact of the user on the vehicle, and to electronically communicate the ride report to provide a real-time assessment of the user on the vehicle.

2. The collection system of claim 1, wherein the collection module includes instructions to monitor the user and the vehicle including instructions to collect at least one of: images of the vehicle before and after the ride that depict an interior of the vehicle, video of the user over the ride that identify a behavior of the user, and dynamic vehicle data over the ride that identify a vehicle behavior while the user is engaged with the vehicle, and
wherein the dynamic vehicle data includes at least one of: data from a vehicle CAN-bus, vehicle sensor data, and telematics from the vehicle.

3. The collection system of claim 2, wherein the collection module includes instructions to monitor the vehicle including instructions to analyze the image data from the camera using the image recognition, wherein the collection module includes instructions to use the image recognition including instructions to execute a machine learning algorithm that implements image classification to identify changes in an interior condition of the vehicle over the ride, and wherein the report module includes instructions to generate the ride report specifying the changes.

4. The collection system of claim 1, wherein the report module includes instructions to generate the ride report including instructions to use the heuristic to assess the vehicle state information before the ride to establish an initial condition of the vehicle prior to entry by the user including a presence of pre-existing conditions.

5. The collection system of claim 1, wherein the collection module includes instructions to identify the attributes including instruction to determine an insurance policy of the user by accessing a remote server to retrieve insurance data about the insurance policy, and wherein the collection module includes instructions to determine the insurance policy including instructions to assess a scope of coverage in relation to a rideshare and deny the ride request when the ride is not within the scope of coverage.

6. The collection system of claim 5, wherein the report module further includes instructions to, in response to determining the ride is within the scope of coverage, analyze the impact to determine whether damage occurred to the vehicle according to a defined damage criterion; and
in response to the damage occurring as a result of the impact exceeding the defined damage criterion, electronically communicate the ride report and insurance policy information obtained from the insurance data to an owner of the vehicle, and
process a third-party electronic claim for the owner in accordance with the scope of coverage.

7. The collection system of claim 1, wherein the report module includes instructions to electronically communicate a notification to the user and an owner of the vehicle when the real-time assessment exceeds a defined damage criterion including instructions to wirelessly transmit the ride report to a mobile device of the user and a mobile device of the owner.

8. A non-transitory computer-readable medium for collecting information from a vehicle for damage assessment during a ride and storing instructions that when executed by one or more processors cause the one or more processors to:
in response to receiving a ride request from a user, identify attributes associated with the user in relation to the ride;
monitor the user and the vehicle to collect, from one or more vehicle systems of the vehicle, vehicle state information associated with the ride including analyzing sensor data using at least image recognition to generate the vehicle state information; and
generate a ride report specifying at least changes in a condition of the vehicle according to the vehicle state information,
wherein the instructions to generate the ride report include instructions to score the vehicle state information according to a heuristic to assess an impact of the user on the vehicle, and to electronically communicate the ride report to provide a real-time assessment of the user on the vehicle.

9. The non-transitory computer-readable medium of claim 8, wherein the instructions to monitor the user and the vehicle include instructions to collect at least one of: images of the vehicle before and after the ride that depict an interior of the vehicle, video of the user over the ride that identify a behavior of the user, and dynamic vehicle data over the ride that identify a vehicle behavior while the user is engaged with the vehicle, and
wherein the dynamic vehicle data includes at least one of: data from a vehicle CAN-bus, vehicle sensor data, and telematics from the vehicle.

10. The non-transitory computer-readable medium of claim 9, wherein the instructions to monitor the vehicle includes instructions to analyze the sensor data from one or more cameras of the vehicle using the image recognition, wherein the instructions to use the image recognition include instructions to execute a machine learning algorithm that implements image classification to identify changes in an interior condition of the vehicle over the ride, and wherein the instructions to generate the ride report include instructions to specify the changes.

11. The non-transitory computer-readable medium of claim 8, wherein the instructions to identify the attributes includes instructions to determine an insurance policy of the user by accessing a remote server to retrieve insurance data about the insurance policy, and wherein the instructions to determine the insurance policy includes instructions to assess a scope of coverage in relation to a rideshare and deny the ride request when the ride is not within the scope of coverage.

12. The non-transitory computer-readable medium of claim 11, wherein the instructions further include instructions to, in response to determining the ride is within the scope of coverage, analyze the impact to determine whether damage occurred to the vehicle according to defined damage criterion; and
in response to the damage occurring as a result of the impact exceeding the defined damage criterion, electronically communicate the ride report and insurance policy information obtained from the insurance data to an owner of the vehicle, and
process a third-party electronic claim for the owner in accordance with the scope of coverage.

13. A method of collecting information from a vehicle for damage assessment during a ride, comprising:
in response to receiving a ride request from a user, identifying attributes associated with the user in relation to the ride;
monitoring the user and the vehicle to collect, from one or more vehicle systems of the vehicle, vehicle state information associated with the ride including analyzing sensor data using at least image recognition to generate the vehicle state information;
generating a ride report specifying at least changes in a condition of the vehicle according to the vehicle state information, wherein generating the ride report includes scoring the vehicle state information according to a heuristic to assess an impact of the user on the vehicle; and
electronically communicating the ride report to provide a real-time assessment of the user on the vehicle.

14. The method of claim 13, wherein monitoring the user and the vehicle further includes collecting at least one of: images of the vehicle before and after the ride that depict an interior of the vehicle, video of the user over the ride that identify a behavior of the user, and dynamic vehicle data over the ride that identify a vehicle behavior while the user is engaged with the vehicle, and
wherein the dynamic vehicle data includes at least one of: data from a vehicle CAN-bus, vehicle sensor data, and telematics from the vehicle.

15. The method of claim 14, wherein monitoring the vehicle includes analyzing the sensor data from one or more cameras of the vehicle using the image recognition, wherein using the image recognition includes executing a machine learning algorithm that implements image classification to identify changes in an interior condition of the vehicle over the ride, and wherein generating the ride report further includes specifying the changes.

16. The method of claim 13, wherein generating the ride report further includes using the heuristic to assess the vehicle state information before the ride to establish an initial condition of the vehicle prior to entry by the user including a presence of pre-existing conditions.

17. The method of claim 13, wherein identifying the attributes includes determining an insurance policy of the user by accessing a remote server to retrieve insurance data about the insurance policy, and wherein determining the insurance policy includes assessing a scope of coverage in relation to a rideshare and denying the ride request when the ride is not within the scope of coverage.

18. The method of claim 17, further comprising:
in response to determining the ride is within the scope of coverage, analyzing the impact to determine whether damage occurred to the vehicle according to a defined damage criterion; and
in response to the damage occurring as a result of the impact exceeding the defined damage criterion, electronically communicating the ride report and policy information obtained from the insurance data to an owner of the vehicle, and processing a third-party electronic claim for the owner in accordance with the scope of coverage.

19. The method of claim 13, further comprising:
electronically communicating a notification to the user and an owner of the vehicle when the real-time assessment exceeds a defined damage criterion by wirelessly transmitting the ride report to a mobile device of the user and a mobile device of the owner.

20. The method of claim 13, wherein monitoring includes identifying when other passengers are present in the vehicle, and wherein generating the ride report further includes parsing the vehicle state information to extract state information associated with the user and scoring the state information according to the heuristic to assess the impact on the vehicle directly attributable to the user in comparison to the other passengers.
